(19) United States
(12) Patent Application Publication
(10) Pub. No.: US 2024/0020097 A1
(43) Pub. Date: Jan. 18, 2024

(54) TDS

(71) Applicant: Damian Czapiewski, Chester (GB)

(72) Inventor: Damian Czapiewski, Chester (GB)

(21) Appl. No.: 18/169,074

(22) Filed: Sep. 19, 2023

(30) Foreign Application Priority Data
Feb. 15, 2022 (GB) 2201947.5

(51) Int. Cl. G06F 8/33

(52) U.S. Cl. CPC G06F 8/33

(57) ABSTRACT

Top-down (alternative name: TDS—Top-down system) is a system for generating programming code, using large language models trained on code. The known limitation of large language models is that they can generate snippets of code, but they usually can't generate coherent applications consisting of many lines of code because of large language models not being aware of the context of the codebase. Top-down eliminates that limitation (to an extent) by generating the application (or part of it) in chunks. It applies top-down programming to generating code with large language models.

### GOAL

Top-down (alternative name: TDS—Top-down system) is a system for generating programming code in various programming languages.

Top-down can generate code of a function tree (definition of a function tree is provided later), but it can also generate code of an entire application (for example console application, web application or mobile application). Those applications can then be used to have some positive impact in people's lives. The code of a function tree can be used as part of some application.

Under the hood, Top-down uses large language machine learning models trained on code like for example Codex to generate code. The current large language models have certain limitations, when they are used in the standard way. Top-down eliminates those limitations to a large extent by using those large language models in a specific way. Top-down system is a system that is executed in an automated way. It can generate large reliable amounts of code in a short time.

Specifically, large language models are unable to produce large amount of coherent code (code that works correctly). Because of that, large language models are unable to generate complex applications without any help of a human. Top-down system solves that limitations (to an extent). Top-down helps to generate large amounts of coherent code that works. The output of Top-down doesn't always work (just like the output of large language model), it can happen that top-down system will generate invalid code, but generally top-down helps to generate better output using large language models.

### SYSTEM

### Terminology

Let's start by introducing some terms that we will later use to describe Top-down system.

Function—when we talk about function, we refer to function in the context of programming. Function is therefore code in a programming language containing declaration, definition and optionally a docstring. Docstring is a text describing what the function does, its arguments and returned value. A method of a class is also considered a function.

Header of a function—the declaration of a function and a docstring describing the function.

Codebase—the code of the application that the system works with. It can be split into multiple files.

Function F is a child of function G—function G executes a call to function F (in its definition).

Function F is a parent of function G—function F executes a call to function G (in its definition).

Function F is a descendant of function G—function F is called by the function G (in the definition of function G) or it is called by one of the descendants of the function G (i.e. a child of the function G or a child of a child of function G or child of a child of a child of function G etc. calls function F).

Function tree with root at function F—set of functions that includes the function F and all of the descendants of the function F (and does not include any other function).

Code of a function tree T—code consisting of all functions belonging to the function tree T merged in such way that it can be used as valid code (e.g. each function is separated with two characters representing new line).

Main function—Top-down system can be used to generate a function tree. When the Top-down system is used to generate the function tree with root at function F, then we say that the function F is the main function.

External function—function that is defined outside of our codebase or a function that is built-in in the programming language.

Unit—function, class, struct or a method.

Unit M is a descendant of unit N—unit M is called by the unit N (in the definition of unit N) or it is called by one of the descendants of the unit N (i.e. a child of the unit N or a child of a child of unit N or child of a child of a child of unit N etc. calls unit M).

Input

The input of the Top-down system is a header (a declaration and a docstring) of the main function.

If we want to use the Top-down system to generate entire application, then the input is a description of that application.

Output

The output of the Top-down system is the code of the function tree with root at the main function (the function of which the header was given as an input).

If we want to use the Top-down system to generate entire application, then the output is the code of that application.

Generating Entire Applications

Top-down system can be used to generate entire applications (mobile applications, web applications, other applications . . . ).

Top-down system generates entire application by creating function tree with root at the function that is responsible for running the entire application. For example, in C++ each program has to contain function main. Top-down system generates an entire C++ application by generating the function tree with root at the function main. In other programming languages like Python, a program doesn't have to contain that function. But we can define a function like that and then call it in our program.

Therefore, if we want to use Top-down system to generate entire application, then the system consists of 3 steps:
1. Prepare the header of the function main (that function can also have a different name) based on the description of the application given as an input. This can be accomplished using large language model with a special prompt for generating the header of the main function, given the description of the application.
2. Generate the code of the function tree with the root at function main (using the process described below).
3. Construct a program consisting of the generated function tree and a call to function main.

Sometimes it might be a good idea to have multiple main functions. For example, if we want to generate a web application written in PHP based on Symfony Framework, then each action of the controller can be the main function and we can generate function tree for each action in the controller. The entire application will then consists of all the code (from all function trees) merged together plus the code from the Symfony Framework.

Regardless of if we have multiple main functions or not, a program consists not only of the code inside functions but also the code outside of the functions. That code can import some functions from other modules or initialize some global variables, for example. That code also needs to be included in the program. I will show to generate that code later.

Top-Down System—Main Process

The following process is the process that Top-down system use to generate code of a function tree.
1. Generate definition of the main function using large language model (without generating the descendant functions). You can do that by using the main function header as a prompt.
2. Analyse the generated definition to find all calls to other functions. Sort the calls in the order in which they are executed. For each call, retrieve the function name of the function that is called (from the generated definition).
3. For each function name N that we have found in the point 2: a) If the function is external (meaning that the function is supposed to be imported from the package outside the codebase, e.g. Python “requests” package), then don't do anything—go to the point 4. b) Generate the code of the function tree with root at function F, where function F is the function with the name N (and the main function will execute a call to that function). Generate that code by following the subprocess described below (in the next section).
4. The output of the system is the code of the main function (with the generated definition, generated in the point 1) merged with all the generated code of the function trees generated in the point 3.

Additional Comments:
1. “Sort the calls in the order in which they are executed”. “Executed” in that context means that if a call A is executed in a line X and call B is executed in a line Y, where X<Y, then the call A is executed before call B; if the calls are in the same line, then the one that is more nested is executed first. “Nested” in that context means that the call to that function will be executed sooner, when the code is executed.
2. How can we find undefined functions? There are multiple ways to do that, but we can find them using regular expressions or by using an algorithm (the algorithm depends on the programming language for which we generate code).
3. How can we recognize if a function called at some place in the definition is an external function? There are multiple ways to do that, but we can do that by constructing a prompt that contains the definition and then a new line. The large language model will likely generate the code of the functions that are not external with a prompt like that. The large language model is less likely to generate the code of the external functions because the large language model is likely to know that the code of those functions is somewhere else (outside of the generated code).

Top Down System—the Subprocess:

The goal of this subprocess is to generate code of the function tree with root at a descendant of the main function (I will denote that descendant as function D). This process is used as part of the main process (it is referenced in the point 3b of the main process).

### Terminology

1. Functions related to a function F—functions that need to be known by a large language model (their code needs to be included in the prompt) in order for the large language model to be able to generate the definition of the function F. Precisely speaking, they don't necessarily “need to be known”, but they increase the probability of the large language model knowing what code to generate. We can also say that a unit is related to other unit. The definition of “unit related to other unit” is analogical to “function is related to other function”.

Process:
1. Find the functions in the codebase that are likely to be the most related to the function D. I will later describe how to find them.
2. Generate the definition of the function D. Do that by including the code of the most related functions (including the header and the definition) in the prompt that is passed to the large language model. End the prompt with the beginning of the function D (e.g. if you generate code in Python, the beginning can be “def
3. Analyse the generated definition to find all calls to other functions. Sort the calls in the order in which they are executed. For each call, retrieve the function name of the function that is called (from the generated definition).
4. For each function name N that we have found in the point 3: a) If the function is external (meaning that the function is supposed to be imported from the package outside the codebase, e.g. Python “requests” package), then don't do anything—go to the point 5. b) Generate the code of the function tree with root at function F, where function F is the function with the name N (and the function D will execute a call to that function). Generate that code by following the subprocess of the Top down system (the one that you read at the moment).
5. The code of the function tree with root at the function D is the code of the function D (with the generated definition, generated in the point 2) merged with all code of the function trees generated in the point 4.

The key idea of the system is that if we want to generate code that accomplishes task T, then we can do that by splitting the task T into simpler tasks by generating (using large language model) the definition for a function that aims to accomplish the task T and then generating definitions for the descendants of that function using the same process (by splitting the task into even simpler tasks and then splitting them into simpler tasks until the task will be simple enough). We can do that not only with functions but with units in general—I will talk more about applying it to other units than functions in “Object-oriented programming” section.

Additional Comment:
1. If the generated definition contains a call to a function that was included in the prompt, then we don't generate function tree with root at that function. Instead, we assume that the large language model meant to make a call to the function in the prompt, so we don't need to generate function with the root at that function (because it will be generated at some other time).

How to Find the Related Functions

The related functions of the function F usually are:
1. The function that is the parent of the function F. A function can have multiple parents, in that case we include all of the parents.
2. The previous siblings of the function F (excluding external functions). The siblings are the functions that are also called by the parent of the function F. The previous siblings are the siblings that are called before the function F in the definition of the parent.

Presuming that the docstring of all functions contains all the information that is necessary to understand what the function does, its arguments and its returned value, then the code of the above functions should be enough to generate the definition of the function F by the large language model.

When we want the large language model to work with object-oriented programming (I will explain later in more detail how to make it work object-oriented programming), then we should also include the code of the classes that are either type of an argument or returned value in one of the functions that are included in the prompt. Otherwise, the large language model will not know what it should exactly return (e.g. if the large language model can see that one of the functions returns an object of class Task, but it doesn't know what the properties of that class are, then it won't be able to know how to work with that object). We don't need to include the code of the methods of that class (we can truncate the methods)—the class declaration, the docstring of the class and its public properties (also, getters and setters if they exist) should be enough.

It is optional but recommended to include the functions that are semantically similar (as related functions) in the prompt. For example, we can use embeddings of the snippets of code contained by the codebase to find functions from the codebase that are related to the docstring and definition or the name of the generated function. We can then include the most semantically similar function in the prompt as related functions.

Testing

When we generate definition of each function (or other unit), we can test it using automated tests. We can do in two ways. The first way (unit test) is by mocking the returned values of each child. The second way (integration test) is without mocking the returned values. The second test will therefore test not only the function for which we generate the definition, but also all of its descendants (because if we don't mock the returned values, then the descendants must work in order for the main function to work). If any of the tests fail, then we can repeat the entire process of generating the definition for a function (or other unit) for which the test failed (including generating the definitions for the descendants).

It is recommended to apply the first way of testing (with mocking) before generating the definitions for the descendants. That way, we can avoid generating the descendants when the function doesn't work. The second way of testing should be applied after generating the definitions for the descendants because only then it can work.

Thanks to testing, the system can generate better output because it can generate definitions until the tests pass. We can for example make 5 attempts (or any other number) to generate working definition/definitions. If the system succeeds to generate code that passes the tests in those 5 attempts, then we have working code. If the system fails to generate working code in those 5 attempts, then it can generate incomplete code (that will be completed by human). What I mean is that we can test the code with multiple attempts at the level of a function—if the function doesn't work, then we can regenerate it again.

Alternatively, if the tests fail, we can make the system correct its own code—using the output generated by the large language model given the incorrect code and the output from the testing tool (like for example PyTest or PHPUnit).

Object-Oriented Programming

The process above assumes that the generated code will be always in the procedural style. If the large language model generates a definition that will generate code that executes a constructor of a class or a method, then the system will not work. In order to deal with that, we can apply analogical process to creating classes and methods as we apply to functions. In the steps of the process in which we find the calls to other functions, we should also look for initializations of new instances (of a class) and calls to methods. If we find an initialization of an instance, then we need to generate the header of that class with the constructor of that class and properties of that class (stripping the methods that large language model generates, except for setters and getters). If we find a method, then we need to generate the definition of that method (and then follow analogical process to the described above to generate the descendants of that method). The difficulty here can be knowing to which class the newly generated method should belong. We can get that information either through analysis of the code using an algorithm or we can ask the large language model about what class the method belongs to, given the code. By “asking the large language model”, I mean use the large language model with the prompt that asks a question like for example “Which class does the method X belong to”. We can give possible answers. The possible answers will contain all of the types that are used in one of the functions that are included in the prompt used to generate the definition.

Code Outside of the Functions/Units

We also need to generate code for other things that are outside functions (or other units) like:
1. imports (importing packages, modules),
2. initializations of global variables,
3. decorators of functions (in Python).

We can generate those using the large language model with special prompts. For example, in order to generate the imports, we can generate them for each function by constructing a prompt including the definition of the function and then something that suggests that the next thing generated by the large language model will be the imports.

As for globals, if we generate some globals, we need to include them in the prompt that is used to generate the definition. That is because any of the generate functions might need to make use of those globals, therefore it needs to be aware of those globals.

As for imports, based on them we can conclude in which file the given function (or other unit) should be included. For example, if the generated imports in Python language are like this: from .validation import validate, we can assume that the function validate ( ) needs to be located in the file “validation.py”.

Diagram

Let's suppose for example that the task for which we generate code is to draw a rectangle and a triangle on the computer screen.

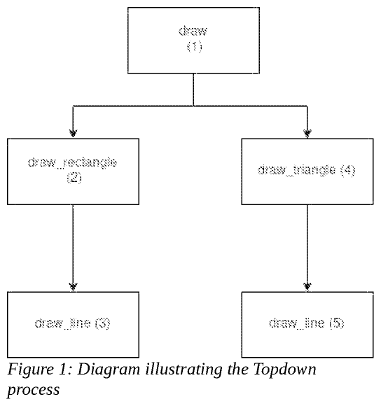

The diagram (FIG. 1 from the drawings) that has been attached to the application shows an example of the functions that the Top-down system might generate in order to generate the function tree aiming to accomplish that task. The number in the brackets informs about the order in which the function will be generated (we can also generate them in a different order, but that order is recommended because only with the order like that we can include the definition of the previous siblings in the prompt).

1. Top-down system—a system for generating code of an application or a function tree (as defined in the description) that generates code in chunks, and applies tap-down programming approach to generating code using large language models.
